(19) United States
(12) Patent Application Publication
(10) Pub. No.: US 2008/0205524 A1
(43) Pub. Date: Aug. 28, 2008

(54) Multiple Instance Video Decoder For Macroblocks Coded in Progressive and an Interlaced Way

(75) Inventor: Stephane Edouard Valente, Paris (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/915,399

(22) PCT Filed: May 18, 2006
(86) PCT No.: PCT/IB2006/051584

§ 371 Date: Nov. 26, 2007

(30) Foreign Application Priority Data
May 25, 2005 (EP) 05300410.7
May 18, 2006 (IB) PCT/IB2006/051584

(51) Int. Cl. H04N 7/01

(52) U.S. Cl. 375/240.16

(57) ABSTRACT

The present invention relates to a video decoder (DEC) for decoding a bit stream (BS) corresponding to pictures (P) of a video signal, the coded pictures being likely to include macroblocks coded in a progressive and in an interlaced way. This decoder comprises a decoding unit (DEU) for decoding macroblocks coded in a progressive way and, according to the invention, a multiple instance unit (MIU) for presenting, for each field-predicted macroblock, a motion compensation vector associated with each field, constructing as many predicted entire macroblocks as fields with each corresponding motion compensation vector, and reconstructing said field-predicted macroblock by re-interlacing fields respectively taken from each corresponding predicted entire macroblock. Use: Mobile devices

### FIELD OF THE INVENTION

The present invention relates to a video decoder for decoding a bit stream in pictures of a video signal, the coded pictures being likely to include macroblocks coded in a progressive and in an interlaced way. More particularly, the invention relates to a decoder including a decoding unit for decoding macroblocks coded in a progressive way.

### BACKGROUND OF THE INVENTION

As indicated in “Information Technology—Coding of audio-visual objects—Part 2: Visual, Amendment 1: Visual extensions”, ISO/IEC 14496-2:1999/Amd. 1:2000, ISO/IEC JTV 1/SC 29/WG 11 N 3056, the MPEG-4 standard defines a syntax for video bit streams which allows interoperability between various encoders and decoders. Standards describe many video tools, but implementing all of them can result in a too high complexity for most applications. To offer more flexibility in the choice of available tools and encoder/decoder complexity, the standard further defines profiles, which are subsets of the syntax limited to particular tools.

For instance, the Simple Profile (SP) is a subset of the entire bit stream syntax which includes in MPEG terminology: I and P VOPs (VOP=Video Object Plane), AC/DC prediction, 1 or 4 motion vectors per macroblock, unrestricted motion vectors and half pixel motion compensation for progressive pictures. The Advanced Simple Profile (ASP) is a superset of the SP syntax: it includes the SP coding tools, and adds B VOPs, global motion compensation, interlaced pictures, quarter pixel motion compensation where interpolation filters are different from the ones used in half-pixel motion compensation, and other tools dedicated to the processing of interlaced pictures.

The document U.S. Pat. No. 6,384,865 discloses a device for de-interlacing an interlaced picture in order to change the size of said picture. Even and odd lines are decoded separately. Then, the resolution is changed before a recombination of the lines in order to form a progressive picture. Such a separate decoding of even and odd lines is precisely what is not available in an SP decoder. This document also discloses a decoder provided with functions enabling the direct decoding of field coded macroblocks as defined in ASP.

Interlacing modifies two low-level processes: motion compensation and inverse Direct Cosine Transform (DCT in the following). In some devices with limited CPU resources or power resources like mobile SP decoders, it can be advantageous to use hardware accelerated functions to carry on some of the decoding operations, even if the hardware acceleration devices are not capable to perform the decoding operations in a conformant way on field-based coded picture. This results in decoding errors which are particularly penalizing in the case of interlaced macroblocks in interlaced pictures.

### SUMMARY OF THE INVENTION

Accordingly, it is an object of the invention to provide a video decoder that uses a decoding unit for decoding progressive pictures and macroblocks and that minimizes penalizing errors concerning the decoding of interlaced pictures, particularly pictures where macroblocks are of a filed-based motion prediction type.

To this end, there is provided a video decoder including a multiple instance unit for presenting, for each field-predicted macroblock, a motion compensation vector associated with each field, constructing as many predicted entire macroblocks as fields with each corresponding motion compensation vector, and reconstructing said field-predicted macroblock by re-interlacing fields respectively taken from each corresponding predicted entire macroblock.

It is thus provided a pseudo-ASP decoder that relies on a decoding unit able to process progressive pictures and, in the case of MPEG-4, on MPEG-4 SP acceleration functions.

In an embodiment, a first predicted entire macroblock is decoded at the location in the current picture of the field-predicted macroblock, other predicted entire macroblocks obtained with the other motion compensation vectors being decoded in additional macroblocks lines after said picture.

In an other embodiment, said multiple instance unit is activated on a picture basis when a flag, decoded or inferred from the bitstream, is set to a value indicating that said picture is interlaced.

The invention also relates to a method for decoding a bit stream corresponding to pictures of a video signal, the coded pictures being likely to include macroblocks coded in a progressive and in an interlaced way, said method including a decoding step for decoding macroblocks coded in a progressive way. Said method is characterized in that it includes, for each field-predicted macroblock presenting a motion compensation vector associated with each field, a step of constructing as many predicted entire macroblocks as fields with each corresponding motion compensation vector, and a step for reconstructing said field-predicted macroblock by re-interlacing fields respectively taken from each corresponding predicted entire macroblock.

The invention also relates to a computer program product comprising program instructions for implementing, when said program is executed by a processor, a decoding method as disclosed above.

The invention also relates to a mobile device including a video decoder according to the invention.

The invention finds application in the playback of video standards as MPEG-4 and DivX streams on mobile phones in which a video encoder as described above is advantageously implemented.

### BRIEF DESCRIPTION OF THE DRAWINGS

Additional objects, features and advantages of the invention will become apparent upon reading the following detailed description and upon reference to the accompanying drawings in which:

FIG. 1 illustrates a macroblock structure in frame DCT coding,

FIG. 2 illustrates a macroblock structure in field DCT coding,

FIG. 3 represents a video decoder according to the invention,

FIG. 4, where the upper part relates to the luminance and the lower part of the chrominance, illustrates a field-based motion compensation for a field-predicted macroblock presenting a motion compensation vector associated with each field,

FIG. 5 illustrates the reconstruction of a field-predicted macroblock presenting a motion compensation vector for each field according to the invention,

FIG. 6 gives an example of an advantageous implementation of the invention.

### DETAILED DESCRIPTION OF THE INVENTION

In the following description, well-known functions or constructions by the person skilled in the art are not described in detail since they would obscure the invention in unnecessary detail.

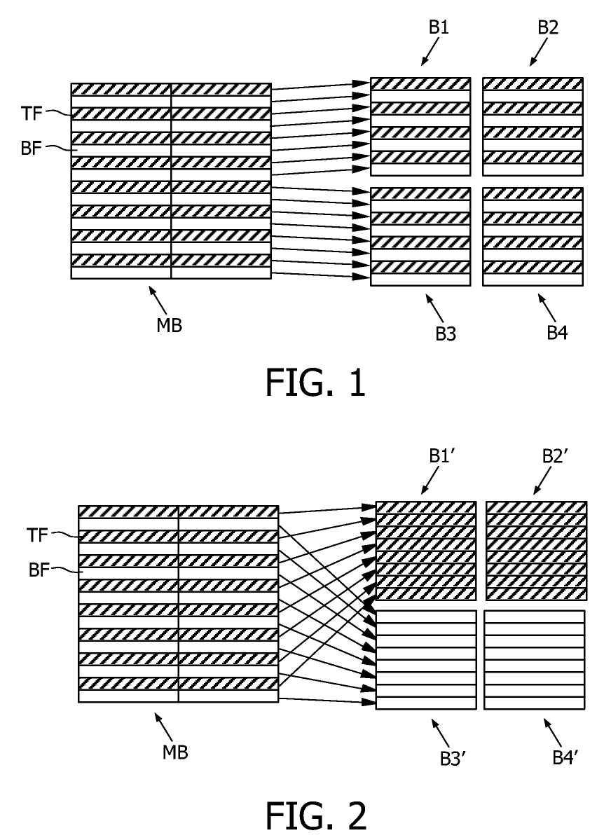

When interlaced pictures are used in an MPEG-4 coding system, the inverse DCT can be either a frame DCT or a field DCT as specified by a syntax element called dct_type included in the bit stream for each macroblock with texture information. When the dct_type flag is set to 0 for a particular macroblock, the macroblock is frame coded and the DCT coefficients of luminance data encode 8×8 blocks that are composed of lines from two fields alternatively. This mode is illustrated in FIG. 1. Two fields BF and TF are respectively represented by blank part and hatched part. FIG. 1 illustrates the frame structure of the 8×8 blocks B1, B2, B3, B4 of an interlaced macroblock MB after frame DCT coding.

When the dct_type flag is set to 1 for a particular macroblock, the macroblock is field coded and the DCT coefficients of luminance data are formed such that a 8×8 block consists of data from one field only. This mode is illustrated in FIG. 2. FIG. 2 illustrates the frame structure of the 8×8 blocks B1′, B2′, B3′, B4′ of an interlaced macroblock MB after field DCT coding. In classical inverse DCT, the luminance blocks B1′, B2′, B3′ and B4′ have then to be inverse permuted back to frame macroblocks. It is here reminded that, generally, even if field DCT is selected for a particular macroblock, the chrominance texture is still coded by frame DCT.

The motion compensation can also either be frame-based or field-based for each macroblock. This feature is specified by a syntax element called field_prediction at the macroblock level in P and S-VOPs, (a Sprite VOP, or S-VOP, is an instantiation of a sprite after a global motion estimation) for non global motion compensation (GMC) macroblocks. Effectively, it has to be noted that global motion compensation is always frame-based in interlaced pictures.

If the field_prediction flag is set to 0, non-GMC motion compensation is performed just like in the non-interlaced case. This can be done either with a single motion vector applied to 16×16 blocks in mode 1-MV, or with 4 motion vectors applied to 8×8 blocks in mode 4-MV. Chrominance motion vectors are always inferred from the luminance ones. If the field_prediction flag is set to 1, non-GMC blocks are predicted with two motion vectors, one for each field, applied to 16×8 blocks of each field. Like in the field DCT case, the predicted blocks have to be permuted back to frame macroblocks after motion compensation. Moreover, field based predictions may result in 8×4 predictions for chrominance blocks, by displacement of one chroma line out of two, which corresponds to one field only in the 4:2:0 interlaced color format.

During encoding, in non-GMC macroblocks, frame and field DCT and frame and field motion prediction can be applied independently from each other. Table 1 summarizes the different combinations that may arise in I-, P- and S-VOPs of ASP streams excluding GMC macroblocks.

TABLE 1

| Case | | DCT | |
|---|---|---|---|
| number | Name | Type | Motion prediction type |
| 1 | Intra frame | Frame | None |
| 2 | Intra field | Field | |
| 3 | Inter 1 MV MC/frame | Frame | 16 × 16 frame-based for |
| | DCT | | luminance |
| 4 | Inter 1 MV MC/field | Field | 8 × 8 frame-based for |
| | DCT | | chrominance |
| 5 | Inter 4 MV MC/frame | Frame | 4 8 × 8 frame-based for |
| | DCT | | luminance |
| 6 | Inter 4 MV MC/field | Field | 8 × 8 frame-based for |
| | DCT | | chrominance |
| 7 | Inter field MC/frame | Frame | 2 16 × 8 field-based for |
| | DCT | | luminance |
| 8 | Inter field MC/field DCT | Field | 2 8 × 4 field-based for |
| | | | chrominance |

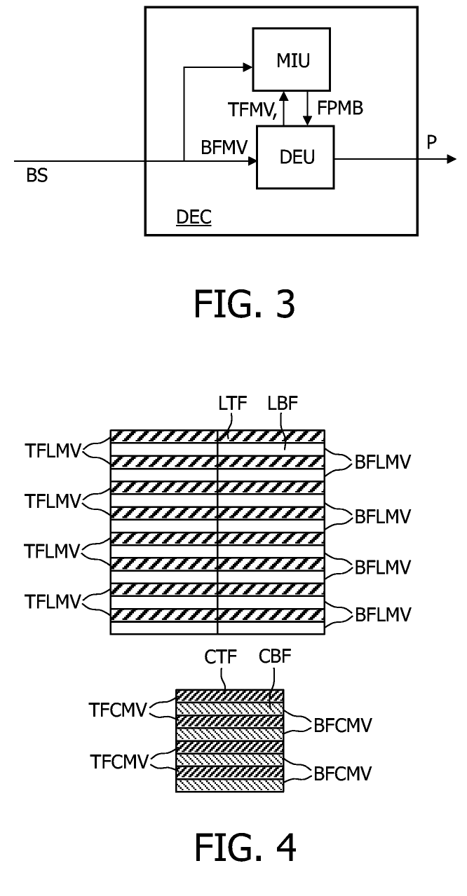

FIG. 3 schematically represents a video decoder DEC for decoding a bit stream BS corresponding to pictures P of a video signal. The bit stream is likely to include macroblocks coded in a progressive way and in an interlaced way. The decoder DEC includes a decoding unit DEU for decoding macroblocks coded in a progressive way and outputting pictures P. It is the case for MPEG-4 Simple Profile decoding functions that can only reconstruct frame-based 8×8 inverse DCT and motion compensate 16×16 or 8×8 frame-based blocks for the luminance channel and 8×8 blocks for the chrominance ones.

The motion compensation of macroblocks of types 7 and 8 (Table 1) is field-based. As illustrated in FIG. 4, for luminance (the upper part of FIG. 4), the top field LBF, represented with hatchings, and the bottom field LTF are predicted with two distinct motion compensation vectors, respectively TFLMV and BFLMV. A similar approach is used for the chrominance (the lower part of FIG. 4) where top CTF and bottom BTF fields are represented with distinct hatchings and are obtained using two distinct vectors, respectively TFCMV and BFCMV. Thus, decoding macroblocks of types 7 and 8 requires to displace two 16×8 field pixels for luminance channel and two 8×4 field pixels for each chrominance channel. This kind of finer level motion compensation exceeds the capabilities of the decoding unit DEU as implemented in the video decoder described in FIG. 3.

In order to be able to decode macroblocks of types 7 and 8, said video decoder includes a multiple instance unit MIU for decoding several macroblocks instead of one for each field-predicted macroblock presenting several motion compensation for each field. Each decoded macroblock instance is specifically designed to stand for some part of the final field-predicted macroblock. It is reminded that an instance of a macroblock is an actual copy of the macroblock content decoded from the bitstream.

To illustrate how the multiple instance unit operates, a macroblock of type 7 is considered. It is a field-predicted macroblock with frame DCT. In a decoder dedicated to process frame and field coded pictures, the macroblock should be reconstructed by first motion-compensating two 16×8 fields for the 16×16 luminance pixels, and two 8×4 for each 8×8 chrominance block. Each field is displaced using its own motion vector, respectively the top field motion vector, TFLMV and TFCMV, and the bottom field motion vector, BFLMV and BFCMV. Then, once the motion prediction has been formed, the residual texture signal is added, by computing six 8×8 inverse DCTs, one for each 8×8 luminance block (4 of them) and one for each 8×8 chrominance block (2 of them).

In the video decoder according to the invention, to obtain the final field-predicted macroblock FPMB by multiple instance decoding, two predicted macroblocks are constructed respectively with the top and bottom field motion vectors TFMV and BFMV. Two 16×16 1-MV frame-predicted macroblocks with frame DCT are thus obtained. Such macroblocks are of type 3 in table 1. They are both constructed with the same frame-based DCT residual texture information that would be used for the final field-predicted macroblock FPMB. The two macroblocks are, for example, stored in order to be used in further reconstruction of the final field-predicted macroblock FPMB.

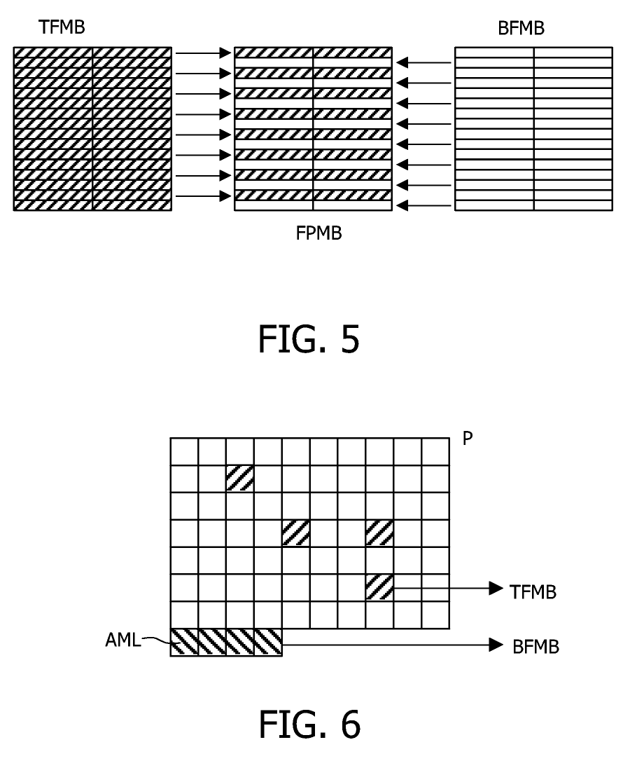

FIG. 5 shows the two obtained macroblocks TFMB and BFMB. Upon completion of the construction of the two macroblocks, the first macroblock TFMB will hold the correct luminance and chrominance top fields for the final field-predicted macroblock of type 7 FPMB, with irrelevant bottom fields, while the second macroblock BFMB will have the correct luminance and chrominance bottom fields, with irrelevant top fields. Consequently, after the multiple instances have been decoded, their relevant parts can be extracted and recombined to form the final field-predicted macroblock FPMB. Thus, the top field of the first macroblock TFMB is then re-interlaced, as illustrated in FIG. 5, with the bottom field of the second macroblock BFMB, in order to obtain the right field-predicted macroblock of type 7 reconstruction. The decoding operations have been duplicated in two separate macroblocks, but each decoded instance by the decoding unit has some correct information for the final macroblock FPMB.

FIG. 6 gives an example of implementation of the invention. In this implementation, the first instances TFMB, represented by a first kind of hatchings, of field-predicted macroblocks FPMB presenting a motion compensation vector for each field are decoded by the decoding unit DEU at the location of their respective final macroblock FPMB within the picture P. The second instances BFMB of the final macroblock FPMB are decoded in additional macroblock lines AML after the picture P.

This implementation presents the advantage that it does not disrupt the regular data flow of hardware accelerations during the decoding of a full picture, the hardware in the decoding unit simply decoding a larger rectangular picture. Moreover it avoids unnecessary pixel copy operations: instead of copying two fields TF and BF to reconstruct a macroblock FPMB as represented in FIG. 5, only the bottom field BF of the bottom field macroblock BFMB has to be copied to its final location in the decoded picture P.

The invention is particularly interesting for processing of video signals on mobile devices like mobile phones. MPEG-4 or DivX streams can thus be processed by reusing an SP decoding unit to decode ASP streams.

It is to be understood that the present invention is not limited to the aforementioned embodiments and variations and modifications may be made without departing from the spirit and scope of the invention as defined in the appended claims. In the respect, the following closing remarks are made.

There are numerous ways of implementing functions of the method according to the invention by means of items of hardware or software, or both, provided that a single item of hardware or software can carry out several functions. It does not exclude that an assembly of items of hardware or software or both carry out a function, thus forming a single function without modifying the decoding method in accordance with the invention.

Said hardware or software items can be implemented in several manners, such as by means of wired electronic circuits or by means of an integrated circuit that is suitable programmed respectively.

Any reference sign in the following claims should not be construed as limiting the claim. It will be obvious that the use of the verb “to include” or “to comprise” and its conjugations do not exclude the presence of any other steps or elements besides those defined in any claim. The article “a” or “an” preceding an element or step does not exclude the presence of a plurality of such elements or steps.

1. A video decoder for decoding a bit stream corresponding to pictures of a video signal, the coded pictures being likely to include macroblocks coded in a progressive and in an interlaced way, said decoder including a decoding unit for decoding macroblocks coded in a progressive way, characterized in that said video decoder includes a multiple instance unit for presenting, for each field-predicted macroblock a motion compensation vector associated with each field constructing as many predicted entire macroblocks as fields with each corresponding motion compensation vector and reconstructing said field-predicted macroblock by re-interlacing fields respectively taken from each corresponding predicted entire macroblock.

2. A video decoder as claimed in claim 1, wherein a first predicted entire macroblock is decoded at the location in the current picture of the field-predicted macroblock, other predicted entire macroblocks obtained with the other motion compensation vectors being decoded in additional macroblocks lines ater the picture.

3. A video decoder claimed in claim 2, wherein said multiple instance unit is activated on a picture basis when a flag, decoded or inferred from the bitstream, is set to a value indicating that said picture is interlaced.

4. A method for decoding a bit stream corresponding to pictures of a video signal, the coded pictures being likely to include macroblocks coded in a progressive and in an interlaced way, said method including a decoding step for decoding macroblocks coded in a progressive way, characterized in that said method includes, for each field-predicted macroblock presenting a motion compensation vector associated to each field, a step of constructing as many predicted entire macroblocks as fields with each corresponding motion compensation vector, and a step for reconstructing said field-predicted macroblock by re-interlacing fields respectively taken from each corresponding predicted entire macroblock.

5. A computer program product comprising program instructions for implementing, when said program is executed by a processor, a decoding method as claimed in claim 4.

6. A mobile device including a video decoder as claimed in claim 1.
